(19) United States
(12) Patent Application Publication
(10) Pub. No.: US 2013/0012625 A1
(43) Pub. Date: Jan. 10, 2013

(54) STRAIN HARDENING BRITTLE MATRIX COMPOSITES WITH HIGH STRENGTH AND HIGH TENSILE DUCTILITY

(76) Inventors: VICTOR C. LI, Ann Arbor, MI (US); Ravi Ranade, Ann Arbor, MI (US); Michael D. Stults, San Mateo, CA (US); Todd S. Rushing, Clinton, MS (US); William F. Heard, Clinton, MS (US); Toney K. Cummins, Vicksburg, MS (US)

(21) Appl. No.: 13/541,189

(22) Filed: Jul. 3, 2012

Related U.S. Application Data
(60) Provisional application No. 61/504,420, filed on Jul. 5, 2011.

(51) Int. Cl. C04B 28/02; C04B 14/04; C04B 14/06; C04B 28/06; C04B 16/06

(52) U.S. Cl. 524/8

(57) ABSTRACT

A new class of ultra-high performance concrete with very high strength and very high tensile ductility (High Strength High Ductility Concrete) is provided that represents the culmination of two high performance cement-based composite systems, namely those of very high strength, and those of very high tensile ductility into a single composite system. The integration of high strength and ductility has been attained via the adoption of micromechanical analysis and design of fiber reinforced brittle matrix composites. In doing so, the new High Strength High Ductility Concrete material dramatically increases the energy absorption capabilities of structural systems employing this material, making it a very good candidate material where hurricanes, earthquake, impact and blast loads are a concern.

### CROSS-REFERENCE TO RELATED APPLICATIONS

This application claims the benefit of U.S. Provisional Application No. 61/504,420, filed on Jul. 5, 2011. The entire disclosure of the above application is incorporated herein by reference.

### GOVERNMENT INTEREST

This invention was made with government support under W912HZ-08-C-0056 awarded by the U.S. Army/ERDC. The government has certain rights in the invention.

### FIELD

The present disclosure relates to cement-based composites and, more particularly, relates to the class of high-performance fiber reinforced cement-based composites.

### BACKGROUND AND SUMMARY

This section provides background information related to the present disclosure which is not necessarily prior art. This section provides a general summary of the disclosure, and is not a comprehensive disclosure of its full scope or all of its features.

In recent times, with the rapid increase of urbanization and globalization there has been increased demand for construction materials with successively improved performance. The increased density of urban centers has served as a catalyst for increasing the heights of newly constructed buildings in which stronger materials are needed to maintain reasonably sized building elements while supporting significantly greater loads. With an increased potential of terrorist activities, structures are now also increasingly designed with blast/impact effects in mind, requiring materials with high energy absorption capabilities.

A new cementitious composite, High Strength-High Ductility Concrete (HSHDC), was developed at the University of Michigan, Ann Arbor, in collaboration with the US Army Engineer Research and Development Center (ERDC), Vicksburg. The micromechanics-based design of HSHDC resulted in an unprecedented combination of compressive strength (166 MPa [24 ksi]) and tensile ductility (3.4%). Mechanical property characterization of HSHDC under direct tension, split-tension, third-point flexure, and uniaxial compression loads are reported and discussed in the present application.

High performance concretes of the present day can be broadly classified into two categories depending on their superior mechanical property—high compressive strength concretes (e.g. VHSC, RPC, Ductal, MDF, and DSP) and high tensile ductility concretes (e.g. ECC, SHCC, and other HPFRCCs). Both types of concrete have their associated advantages in structural applications. High strength concrete facilitates the design of size efficient structural members for very large structures and provides additional strength safety margins (particularly in compression) for strategically critical and protective structures. High ductility concrete prevents catastrophic structural collapse by absorbing massive amounts of energy during extreme load/displacement events, such as earthquakes, hurricanes, projectile impacts, and blasts, and is particularly effective when the failure mode is tension-related. However, the advantage of each type of concrete proves to be a limitation for the other.

High strength concretes inherently have an extremely brittle matrix. Although this limitation is partially alleviated by the use of short fibers, it often results in a tension softening behavior with decreasing load capacity after the formation of very few cracks. On the other hand, high ductility concretes have compressive strengths 2-4 times smaller than the high strength concretes. A combination of high compressive strength and high tensile ductility in one concrete material is highly desirable to ensure resilience of critical structures under extraordinary loads/displacements, which is the motivation for the development of High Strength-High Ductility Concrete (HSHDC).

Recently, a few notable investigations were conducted on combining high compressive strength and high tensile ductility in one concrete but had limited success. The mechanical test results of Ultra High Performance-Strain Hardening Cementitious Composites (UHP-SHCC) were reported in Kamal et al. The best performing UHP-SHCC has an average compressive strength of 96 Mpa (14 ksi) (half that of Very High Strength Concrete [VHSC]) and tensile ductility of 3.3% at 14 days after casting (longer age data are not reported in this reference). The development of another such material, Ultra High Performance-Fiber Reinforced Composite (UHP-FRC), is presented in Wille et al. UHP-FRC has compressive strength of about 200 MPa (29 ksi) and tensile ductility of 0.6% (at least 5 times less than Engineered Cementitious Composites [ECC]). Also invented at the University of Michigan, ECC are the most ductile cement-based materials in the world with tensile ductility ranging from 3-6%. The most widely used commercially Ultra High Performance Concrete (UHPC) is Ductal® which was developed jointly by Bouygues, Lafarge, and Rhodia. Various versions of Ductal® have compressive strengths ranging from 160-240 MPa (23-35 ksi). However, the maximum ductility of Ductal® under direct tension is only about 0.1% (about an order of magnitude less than ECC). In FIG. 1, the compressive strength is plotted against tensile ductility for all these materials, along with the HSHDC according to the principles of the present teachings. None of the previously developed composite materials truly combine the compressive strength of VHSC and tensile ductility of ECC in one material, which is critical for the survival of structures under extraordinary loading conditions.

According to the principles of the present teachings, a new cementitious composite, called High Strength-High Ductility Concrete (HSHDC) is provided. In HSHDC, both the desirable properties of high compressive strength (similar to VHSC developed at ERDC) and high tensile ductility (similar to ECC developed at UM) are integrated into a single material. The micromechanics-based principles that guide the design of ECC, combined with a modified VHSC matrix, led to development of HSHDC. These micromechanics principles and their application to HSHDC development, along with the characterization of HSHDC's interfacial properties, are briefed in the next two paragraphs and presented in detail in two companion papers.

The principles of micromechanics require fulfillment of two necessary criteria for achieving tensile ductility in HSHDC. First, the strength criterion (Equation 1) requires that the cracks initiate at stresses (σ_{ci}) lower than the bridging capacity of the least bridged crack, min(σ₀).

σ_{ci}≦min(σ₀) (1)

Second, the energy criterion (Equation 2) requires that the total available crack-driving energy (J_{b}′) should be greater than the resistance of the composite to crack propagation (Jₜᵢₚ).

Jₜᵢₚ≦J_{b}′ (2)

The fulfillment of these two necessary conditions by the crack-bridging relation of HSHDC (as detailed in the next paragraph) is unique as it has not been achieved by any other cement-based material with compressive strength in excess of 100 MPa (14.5 ksi).

The crack-bridging relation of HSHDC, which determines whether a composite will exhibit tensile ductility based on Equations 1 and 2, was determined analytically and verified experimentally as detailed in Ranade et al. The crack-bridging relation of HSHDC is determined analytically using a scale-linking model which translates the fiber/matrix interfacial (micro-scale) properties (obtained through single-fiber pullout tests) to single-crack bridging (meso-scale) behavior of HSHDC. This analytically computed single-crack behavior is also verified experimentally using single-crack tests. As detailed in Ranade et al, the minimum bridging capacity [min(σ₀)] (refer to Equation 1 above) across various cracks of a dogbone specimen (FIG. 2) is about 13.0 MPa (1.9 ksi) whereas the crack initiation stress (σ_{ci}) of the first crack is 8.3 MPa (1.2 ksi). Thus, the min(σ₀) and σ_{ci} satisfy Equation 1. The crack-bridging relation of HSHDC also provides the complimentary energy (J_{b}′ in Equation 2), which is about 1000 J/m² in dogbone specimens. This value of J_{b}′ clearly exceeds the crack tip toughness (Jₜᵢₚ in Equation 2) which is only about 25 J/m² computed from matrix fracture toughness tests (Ranade et al). Thus, J_{b}′ and Jₜᵢₚ satisfy Equation 2. Hence, both the criteria for achieving tensile ductility are satisfied by the crack bridging relation of HSHDC, which facilitates high tensile ductility in such a high strength concrete.

Since the first version of HSHDC reported in Ranade et al, significant improvements through deliberate matrix and fiber modifications have been made for achieving robust tensile ductility and minimization of variability in composite properties using the aforementioned principles of micromechanics. The present application will present, in addition to a complete description of the composition of the present invention, the results of the macroscopic characterization tests of the improved version of HSHDC under uniaxial compression, direct tension, split-tension, and flexure loading.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a Tensile Ductility versus Compressive Strength graph illustrating the performance of the present teachings in comparison with conventional teachings;

FIG. 2 is a schematic diagram of a dogbone specimen for use in testing the present teachings;

FIG. 3 is a Strain versus Stress graph of dogbones 1 through 4;

FIG. 4 is a Strain versus Stress graph of dogbones 5 through 8;

FIG. 5 is a Strain versus Stress graph of pre-first crack direction tension test results of four rectangular coupons;

FIG. 6 is a Compressive Machine Displacement versus Splitting Tensile Stress graph illustrating split tension test results of three cylinders that measure 4 inches by 8 inches;

FIG. 7 is a Mid-point Net Deflection versus Flexural Stress graph illustrating third-point flexure test results of three beams that measure 14 inches by 4 inches by 4 inches; and

FIG. 8 are photographs of crack patterns at failure for a (a) beam, (b) dogbone, (c) split-cylinder, and 51 mm cube being made of material according to the present teachings.

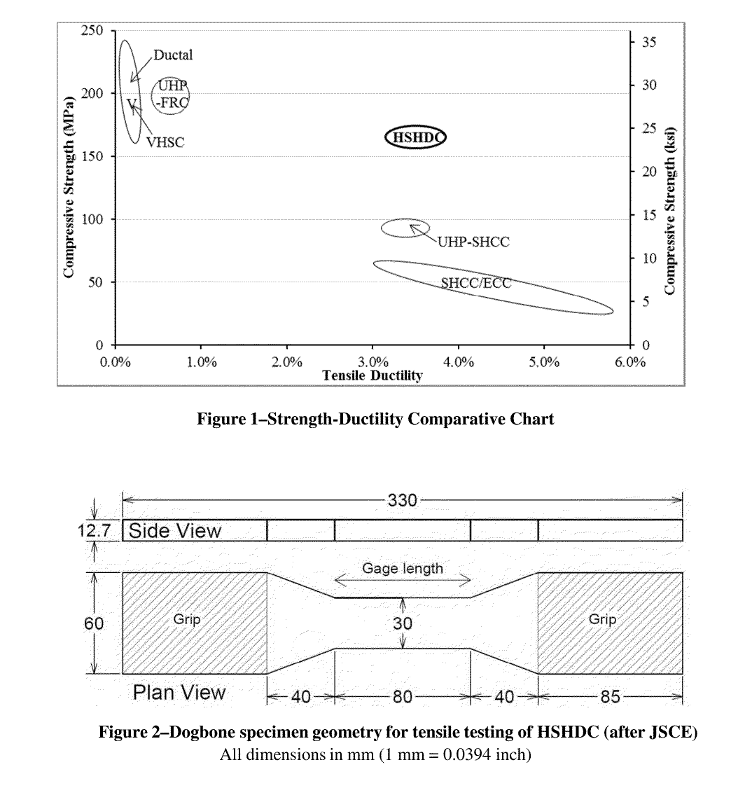

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The importance of the determination of macroscopic mechanical properties of HSHDC (or any other material) is well highlighted in the Integrated Structures and Materials Design (ISMD) approach. Similar to ECC, HSHDC is a micromechanically tailored material. The macroscopic material characterization of HSHDC is required to validate the predictions of micromechanics and scale-linking models. Towards higher length scales, the composite properties of HSHDC determined in the present application can be used in structural analysis models to predict the structural behavior and design the structures efficiently. Thus, the macroscopic material properties of HSHDC are a crucial link between micro-scale material ingredient characteristics and structural performance. The composite mechanical properties of HSHDC reported in the present application clearly demonstrate the feasibility of combining both strength and ductility into a single advanced concrete material.

### Experimental Investigation

### Materials and Mix Proportions

HSHDC consists of cementitious materials, fine aggregates, fibers, water, and HRWRA; the proportions of these ingredients relative to each other are unique. As detailed below, these proportions promote not only high compressive strength through dense packing of highly reactive cementitious materials but also high tensile ductility by lowering the fracture toughness of the matrix. The mix proportions of HSHDC are given in Table 1.

TABLE 1
Mix Proportions of HSHDC

| | | | Acceptable Range |
|---|---|---|---|
| | Weight per unit | | of Proportions |
| | volume in this | | w.r.t. cement |
| | illustration | | (Proportion in this |
| Constituent | (kg/m³) | (lb/yd³) | illustration) |
| Cement (Class H) | 907 | 1528 | 1 (1) |
| Microsilica (Silica Fume) | 353 | 595 | 0-0.6 (0.389) |
| Ground Silica (Silica Flour) | 251 | 423 | 0-1.0 (0.277) |
| Silica Sand | 635 | 1070 | 0-2.0 (0.700) |
| Tap Water | 189 | 318 | 0.1-0.4 (0.208) |
| HRWRA | 16 | 27 | 0-0.03 (0.0175) |
| PE Fiber* | 19 | 33 | By Total Mix Volume |
| | | | 1%-4% (2%) |

*Properties of the PE fiber are given in Table 2

The most unique ingredient of HSHDC are the ultra-high molecular weight (>16,000,000 g/mol or 100,000 monomers) Polyethylene (PE) fibers randomly distributed in the HSHDC matrix. No other cement-based material with such high compressive strength (>100 MPa) has ever used polymer fibers successfully to achieve high tensile ductility. The physical/mechanical properties and the geometry of these PE fibers are given in Table 2. The high strength of the PE fiber coupled with the dense fiber/matrix interface, due to a densely packed HSHDC matrix, enables strong bridging without fiber rupture. The hydrophobic nature of the PE fiber minimizes chemical bonding with the cementitious matrix and leads to a high complementary energy of crack-bridging favorable for multiple steady-state cracking, as explained in Ranade et al. The aspect ratio of the PE fiber used in connection with the present teachings was 450. Higher aspect ratio leads to more efficient utilization of the strength of the PE fiber resulting in higher crack bridging capacity. The high strength and high aspect ratio of the PE fiber, along with the interfacial frictional bond, are critical HSHDC design considerations from a fiber selection point of view.

TABLE 2
Geometry and Mechanical/Physical Properties of the PE Fiber

| | Values used | | |
|---|---|---|---|
| | in this | Acceptable | |
| Fiber Properties | illustration | Range of Values | |
| Diameter (d_{f}) μm | 28 (0.0011) | 10-100 | (4 × 10⁻⁴-4 × 10⁻³) |
| (in) | | | |
| Length (L_{f}) mm (in) | 12.7 (0.5) | 4-25 | (0.15-1) |
| Volume Fraction | 2% | 1%-4% | |
| (V_{f}) | | | |
| Nominal Strength | 3000 (435) | 1000-5000 | (145-725) |
| (σ_{f0}) MPa (ksi) | | | |
| Nominal Young's | 100 (14500) | 10-150 | (1450-21755) |
| Modulus GPa (ksi) | | | |

| | | |
|---|---|---|
| Specific Gravity | 0.97 | 0.7-1.5 |

The cementitious materials used in HSHDC mixture of Table 1 were Class H cement and microsilica (silica fume). Class H cement (also called “oil-well cement”) is characterized by low calcium aluminate content and coarse particle size (mean diameter is 30-50 μm and Blaine fineness of 200-260 m2/kg). Compared with other chemically similar cements of finer size, the larger particle size in Class H cement exerts lower water demand which results in a denser microstructure. Microsilica was used as a highly reactive supplementary cementitious material to promote the formation of secondary hydration products, thereby maximizing the calcium silicate hydrate (CSH) content. A polycarboxylate-based high range water reducing admixture (HRWRA) was used to maintain flowability and rheology of the mix at the very low water-cementitious material ratio (w/cm) of 0.15 used in HSHDC. The cementitious materials in HSHDC were selected to reduce the water demand, increase the formation of CSH, and promote homogeneity of the mix, all of which contribute to the high compressive strength performance.

The aggregates or fillers used in the HSHDC matrix were primarily fine silica sand and ground silica (silica flour) supplemented by unreacted microsilica particles. Fine silica sand with a mean diameter of about 270 μm (maximum aggregate size of 600 μm) was used. Using such a small aggregate size reduces the size of the weak interface between aggregate and cement. Smaller aggregate also reduces the fracture toughness of the matrix (due to reduced aggregate interlock) for crack initiation and fracture work during steady state crack propagation (due to reduced tortuosity of the crack path), both of which are desirable for composite ductility according to micromechanics. A lower weight ratio of silica sand/cement (0.7) was used in connection with the present teachings. Fine particles of microsilica (0.1-1 μm) and ground silica (5-100 μm) increase the density of the matrix and aggregate-cement interface by filling the larger voids. Thus, the aggregates or fillers in the HSHDC matrix were intended to increase particle packing density, strengthen the aggregate-cement paste interface, and limit the matrix fracture toughness.

### Specimen Preparation

In connection with the present teachings, dogbone-shaped specimens (FIG. 2) were used to measure the complete stress-strain relation of HSHDC under direct uniaxial tension. The dogbone-shaped specimen geometry is recommended by the Japan Society of Civil Engineers (JSCE) for standardized testing of High Performance Fiber Reinforced Cementitious Composites (HPFRCC) with multiple fine cracks. Eight dogbone specimens of HSHDC were cast and tested in connection with the present teachings. The dogbone geometry forces most of the cracks to occur in the gage region due to its smaller cross-sectional area thus allowing more reliable measurements of the tensile strains.

The tensile elastic modulus of HSHDC was measured using strain gages applied on four rectangular coupon specimens. The dogbone specimens can also be used for this purpose but the rectangular coupons were adopted for convenience in connection with the present teachings. The rectangular coupon specimens with lengths of 254 mm (10 in), widths of 76 mm (3 in), and thicknesses of 12.7 mm (0.5 in) were used. The coupon specimens had a constant cross-sectional area throughout their length which causes more stress concentration in the grip region than the gage.

Along with the above specimens for direct tension testing, specimens for uniaxial compression, split-tension, and flexure testing of HSHDC were prepared. Eight cubes with lengths of 51 mm (2 in), and six cubes with lengths of 76 mm (3 in) were cast for uniaxial compression strength measurements. In addition, three cubes with lengths of 51 mm (2 in) were prepared for measuring compressive elastic modulus using strain gages. Three cylinders with diameters of 102 mm (4 in) and lengths of 203 mm (8 in) were cast for split-tension tests. Three beams with lengths of 356 mm (14 in) (span lengths of 305 mm [12 in]), widths of 102 mm (4 in), and depths of 102 mm (4 in) were cast for third-point flexure tests.

Elevated temperature curing was used for all of the HSHDC specimens. After casting the fresh HSHDC mix into the specimen molds, they were sealed by plastic sheets and cured for two days at room temperature. Due to the higher dosage of HRWRA and the use of oil well cement that is slow setting, the specimens require a longer time to attain the stiffness sufficient for demolding. Subsequently, the hardened specimens were removed from the molds and kept in a water tank for curing at room temperature (23±3° C. [73±5° F.]) for 7 days. This was followed by elevated temperature curing for 5 days in water at 90° C. (194° F.) and for 3 days in air at 90° C. (194° F.). The purpose of the elevated temperature curing was mainly to accelerate the primary and secondary hydration reactions. The temperatures below 100° C. (212° F.) are generally not enough to initiate significant morphological changes to the microstructure of hydration products of oil well cement with low calcium aluminate contents. The HSHDC specimens were further kept in air at room temperature until the age of 28 days after casting, at which time they were tested.

### Experiment Setups and Procedures

The dogbone and rectangular coupon specimens were tested under quasi-static uniaxial tension loading. Aluminum plates were glued to the grip region of the dogbone (shaded region in FIG. 2) and coupon specimens to achieve smooth gripping surfaces, thereby minimizing the stress concentrations. The dogbone and coupon specimens were gripped on these faces in a fixed-fixed type of end constraints. The tensile tests were conducted at 0.5 mm/min (0.02 in/min) using a displacement controlled closed loop test system with a maximum load capacity of 100 kN (22 kips). The strain in the dogbone specimens was computed from the extension of the specimen measured by two ultra-precision LVDTs mounted parallel to the two side edges of the dogbone specimen. The strain in the coupon specimens prior to first crack was measured by two strain gages with a gage length of 2 cm (0.8 in). These strain gages were bonded to either side of the coupon specimens parallel to the longitudinal loading direction. In this arrangement, the planes of the strain gages were parallel to the coupon's plan (length by width).

Along with the direct tension tests, mechanical property tests of HSHDC under indirect tension (split tension and flexure) were also performed in connection with the present teachings. For the split-tension tests, a setup similar to that given in ASTM C496 was adopted. The compressive displacement rate applied on the split-cylinders was 100 μm/min (0.0040 in/min). The third-point flexure tests on HSHDC beams were performed following the ASTM C1609 standard test procedure. A constant mid-point net deflection rate of 50 μm/min (0.0020 in/min) was used in these flexure tests. The mid-point net deflection was computed using an arrangement similar to that shown in FIG. 2 of ASTM C1609 utilizing two LVDTs.

Lastly, the 51 mm (2 in) cubes and the 76 mm (3 in) cubes were used to determine the strength and elastic modulus of HSHDC under uniaxial compression. The test setup for cube compression tests was similar to that given in ASTM C109. The compressive displacement rate applied on the 51 mm (2 in) cubes was 40 μm/min (0.0016 in/min), and on the 76 mm (3 in) cubes was 25 μm/min (0.0010 in/min). A closed loop displacement controlled compression testing machine with maximum load capacity of 2200 kN (500 kips) was used to load the cubes. The compressive strain in three 51 mm (2 in) cubes, cast for measuring the elastic modulus, was measured using two strain gages (gage length of 2 cm [0.8 in]) bonded to the two opposite faces of the cubes parallel to the loading axis. In all the other cubes (other than the above three cubes for measuring elastic modulus), only the compressive machine displacement was measured to reduce the experimental effort, as the main objective of testing these cubes was to measure the compressive strength.

### Results and Discussion

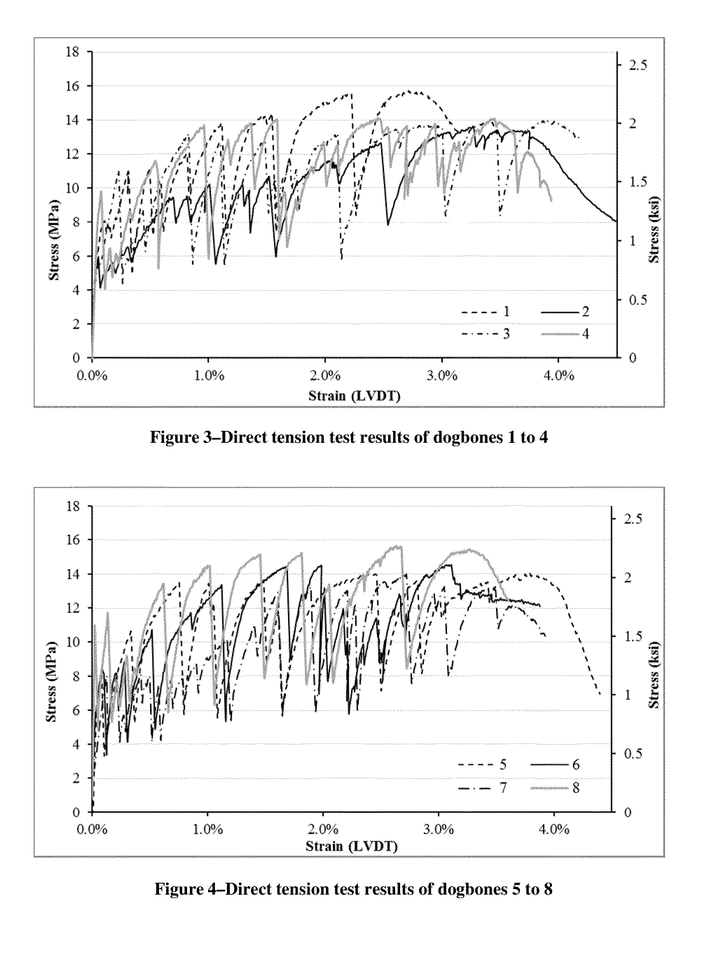

The direct tension test results of all the eight dogbone specimens prepared for this study are shown in FIGS. 3 and 4. The x-axis in these figures shows the average tensile strain computed from the extensions of two LVDTs over the gage length (FIG. 2). The y-axis shows the tensile stress computed from the applied load and specimen cross-sectional area in the gage. The average of the ultimate (maximum) tensile strength of these specimens is 14.5 MPa (2.1 ksi) with coefficient of variation (CV) of 6%. The ultimate tensile strength is governed by the minimum of the bridging capacities at various cracks, which is further dependent on the interfacial bond, fiber volume, and fiber dispersion. The average of the corresponding tensile strain capacities is 3.4% with a CV of 11%. Although most microcracks occur within the gage length, some microcracks do occur in the larger cross-section, so that the measured value of 3.4% represents a lower bound. The average of the first crack strengths of these eight dogbone specimens is 8.3 MPa (1.2 ksi). These unique tensile properties of HSHDC utilizing moderately low fiber volume fraction (2%) are a result of careful micromechanical tailoring of the material as detailed in Ranade et al.

These results from HSHDC dogbone specimens show substantial improvements over the earlier version of HSHDC reported in Ranade et al. The average ultimate tensile strength increased from 11.8 MPa (1.7 ksi) reported in Ranade et al. to 14.5 MPa (2.1 ksi) in connection with the present teachings. The micromechanical analysis revealed a slight increase in the fiber/matrix interfacial frictional bond and a more homogenous dispersion of fibers due to a reduction in the sand/cement ratio; although, the fracture toughness of the matrix remained unchanged. A complete micromechanical analysis of this version of HSHDC is documented by Ranade. In addition, a higher aspect ratio of the PE fiber was used in connection with the present teachings compared to the previous version of HSHDC. The increase in the ultimate tensile strength is a combined effect of these changes in the sand/cement ratio and the fiber aspect ratio. Furthermore, the increase in the ultimate tensile strength caused initiation of smaller flaws into cracks during strain-hardening, which resulted in more consistent multiple cracking and tensile ductility. The variability (CV) in tensile ductility decreased from 40% reported in Ranade et al. to 11% in connection with the present teachings. Such reduction in the material property variability shows better quality control, thereby enabling structural designers to make fuller use of the material properties, especially ductility, through increased statistical reliability. Thus, the enhancements of the composite mechanical properties of HSHDC are a direct result of the deliberate microstructural modifications in matrix and fiber properties.

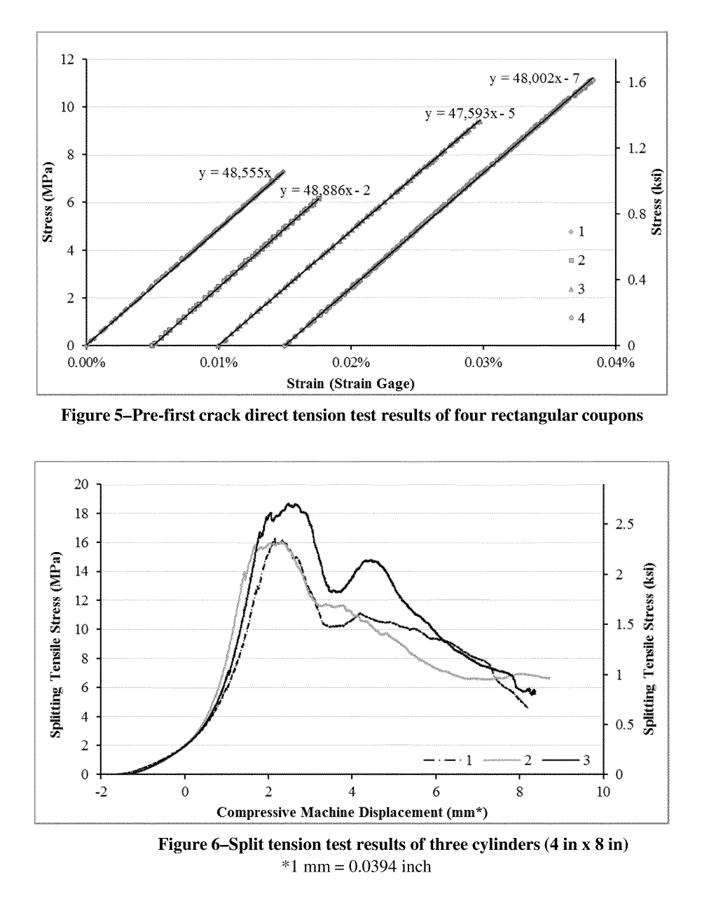

The direct tension test results from four rectangular coupon specimens prior to first-crack were used to determine the elastic modulus of HSHDC under direct tension. The results are shown in FIG. 5. The x-axis in this figure shows the average of the tensile strains measured by two strain gages. The origins (0,0) of these graphs are deliberately offset by 0.005% in order to present the data points of various specimens with clarity. The average first crack strength of the coupon specimens is 8.5 MPa (1.2 ksi) which is very close to that of the dogbone specimens (8.3 MPa). The elastic modulus of HSHDC in tension was computed from the slope of the best-fit straight line through the observed stress-strain data points of each specimen. The average tensile elastic modulus of HSHDC thus computed is 48 GPa (6962 ksi) with CV of 1%.

Apart from the direct tension tests on planar dogbone specimens, the indirect tension tests of split-tension and third-point flexure were also performed in connection with the present teachings. The purpose of these indirect tension tests was to determine the tensile behavior of HSHDC in larger specimens (split-cylinders and beams) with three-dimensional distribution of PE fibers, as well as to evaluate the validity of the use of these simpler tests in place of direct test for HSHDC.

The split-tension test results of three HSHDC cylinders (4 in×8 in) are shown in FIG. 6. In this figure, the y-axis represents the splitting tensile stress computed from the applied compressive load and the dimensions of the cylinder using Equation 1 of ASTM C496. The x-axis in FIG. 6 represents the compressive displacement as measured by the machine stroke. Based on these results, the average split-tensile strength of HSHDC is 17.0 MPa (2.5 ksi) with CV of 8.5%.

The results presented above show that the tensile strength of HSHDC is overestimated by the split-tension tests (17.0 MPa) as compared to that by the direct uniaxial tension tests (14.5 MPa). Split-tension tests were originally designed to determine the tensile strength of normal concrete, which is a brittle material. However, unlike normal concrete, HSHDC shows an extremely ductile behavior which causes a change in the failure mode of the split-cylinders from almost pure tensile cracking to a combination of multiple tensile cracking and compressive crushing. This change in the failure mode of the split-cylinders causes a non-conservative estimation of the tensile strength, and therefore, the split-tensile test is an inappropriate method for evaluating the tensile strength of HSHDC and similar strain hardening materials.

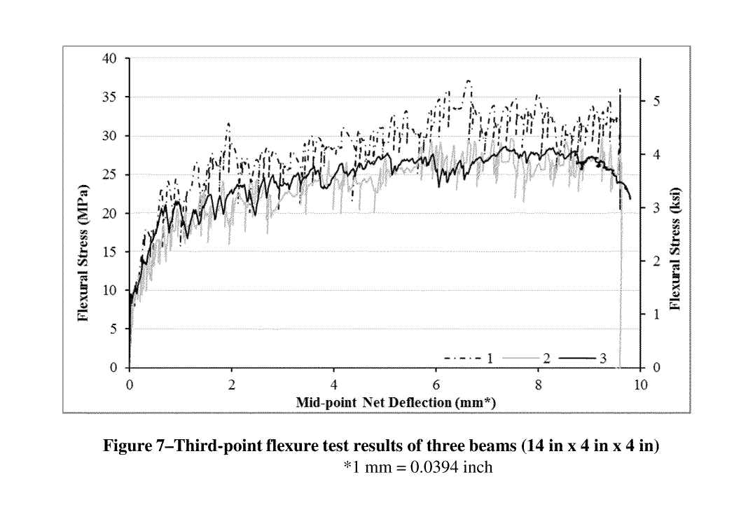

The third-point flexure test results from three HSHDC beams (14 in×4 in×4 in) are shown in FIG. 7. In this figure, the flexural stress is plotted against the mid-point net deflection of the beam. The flexural stress was computed from the applied compressive load and the dimensions of the beam using Equation 1 of ASTM C1609. The mid-point net deflection was computed as an average of extensions of the two LVDTs mounted at the longitudinal centerline of the beam. The average modulus of rupture (MOR) of the three beams thus computed is 31.8 MPa (4.6 ksi) with CV of 14%. Along with such a high MOR, HSHDC beams exhibit extremely high ductility as the average of the mid-point net deflection at MOR is 7.7 mm (0.3 in) which is 2.5% of the span length.

The high structural strength and ductility exhibited by the HSHDC beams are a direct result of its high material strength and ductility. For instance, the MOR of HSHDC beams can be predicted from its properties under uniaxial tension and compression (detailed below) using the analytical model developed by Maalej and Li. This analytical model was originally used to predict the MOR of ECC beams based on the composite properties of ECC under direct uniaxial tension and compression, but it can be applied, without loss of generality, to any strain hardening material. As reported above, the average tensile strain capacity (au) of HSHDC is 3.4%, its average first crack strength (σtc) is 8.3 MPa, and its ultimate tensile strength (σtu) is 14.5 MPa. According to FIGS. 12 and 13 in Maalej and Li, the predicted MOR/σtc ratio is about 4 for a tensile strain capacity (εtu) of 3.4% and σtu/σtc ratio of 1.7 (14.5/8.3). In connection with the present teachings, the MOR/σtc ratio was found to be 3.8, which agrees well with the analytical prediction. This agreement demonstrates the plausibility of using third-point flexure test (which is easier to perform in the field than the direct tension test) as an alternative method for validating the performance of HSHDC; however, more exhaustive testing is required to quantify the reliability of such tests.

Along with the above characterization of the tensile properties of HSHDC, its performance under uniaxial compression was also measured. The uniaxial compression strength results from eight 51 mm (2 in) cubes and six 76 mm (3 in) cubes are shown in Table 3. The average compressive strength of the 51 mm cubes (166 MPa [24.1 ksi]) is slightly (5%) higher than that of the 76 mm cubes (158 MPa [22.9 ksi]). In addition, the strength variability (CV) of the 51 mm cubes (6.1%) is lower than that of the 76 mm cubes (9.7%). These results of strength and variability are consistent with the Ultra-High Performance Concrete (UHPC) cube compression test results reported in an extensive study by the Federal Highway Administration (FHWA). According to Table 12 (steam treated M1B specimens) of the FHWA report, the larger cubes (100 mm) show slightly lower compressive strength and higher variability compared to the smaller (51 mm) cubes. In addition, the average elastic modulus of HSHDC under uniaxial compression as measured for three 51 mm (2 in) cubes is 51 GPa (7397 ksi) with CV of 1%. This value of compressive elastic modulus of HSHDC is approximately equal to that of VHSC (50 GPa) as determined by O'Neil. Thus, in addition to very high tensile ductility, HSHDC exhibits very high compressive strength with a slightly (5%) higher elastic modulus in compression than in tension.

TABLE 3
Uniaxial compression test results

| | Uniaxial Compression | |
|---|---|---|
| | Strength MPa (ksi) | |
| Specimen Number | 51 mm (2 in) cubes | 76 mm (3 in) cubes |
| 1 | 160 (23.2) | 150 (21.7) |
| 2 | 179 (26.0) | 153 (22.2) |
| 3 | 176 (25.6) | 139 (20.2) |
| 4 | 151 (21.9) | 177 (25.6) |
| 5 | 163 (23.6) | 170 (24.7) |
| 6 | 156 (22.7) | 165 (24.0) |
| 7 | 173 (25.1) | — |
| 8 | 171 (24.7) | — |
| Average | 166 (24.1) | 158 (22.9) |
| Standard Deviation | 10 (1.5) | 15 (2.2) |
| Coefficient of Variation (CV) | 6.1% | 9.7% |

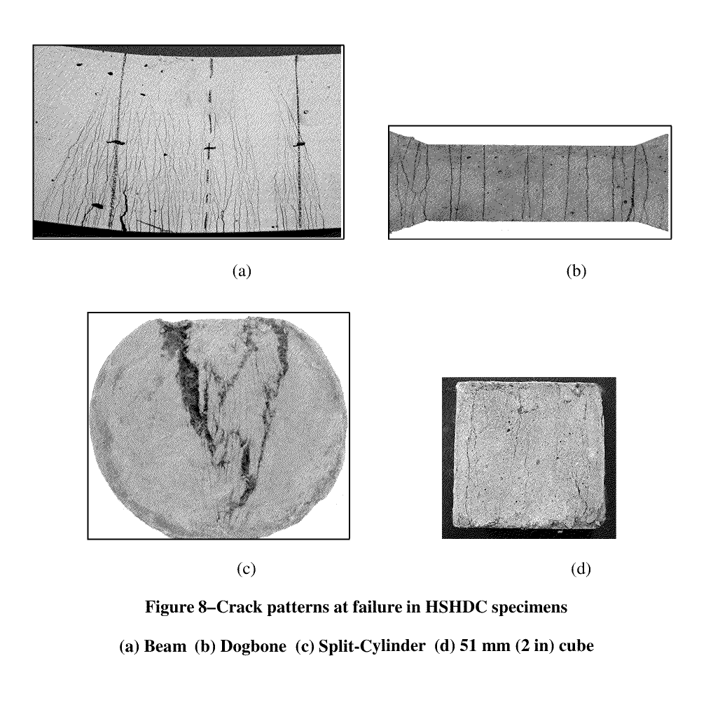

Robust multiple cracking is a distinct feature in all of the tension and compression specimens tested in connection with the present teachings. From the variety of specimens tested under different loading conditions, one representative tested specimen of each kind is shown in FIG. 8 (except the 76 mm cube because its crack pattern is similar to that of the 51 mm cube). Multiple cracking is clearly visible in all the tested specimens. The HSHDC beams exhibit saturated flexural cracking perpendicular to the principal tensile stress field with the crack tips reaching up to about 85% of the total beam depth in the constant moment region of the beam. The average crack opening in the dogbone specimens is about 180 μm (0.0071 in) near the peak load, and the average residual crack opening (after load removal) is about 160 μm (0.0062 in). In spite of higher interfacial frictional bond in HSHDC compared to ECC, the crack openings in HSHDC tensile specimens are 3-4 times larger than ECC due to absence of chemical bond and higher ultimate tensile stress. The cubes remain intact with multiple vertical cracks and negligible spalling after sustaining the maximum compressive load. This micromechanically-tailored controlled micro-cracking of HSHDC results in an extremely ductile mechanical performance under tension and compression loads.

### SUMMARY AND CONCLUSIONS

The composite mechanical properties of HSHDC determined in connection with the present teachings are summarized below:

The average ultimate tensile strength of HSHDC, obtained from eight dogbone specimens, is 14.5 MPa (2.1 ksi) with a CV of 6%. The average of the corresponding tensile strain capacities is 3.4% with a CV of 11%. No other cement-based material in the world with compressive strength in excess of 100 MPa (14.5 ksi) has such high tensile ductility (3.4%), given the small amount of fiber volume (2%) used in HSHDC. The best tensile ductility achieved by a cement-based material in laboratory with over 100 MPa compressive strength was 0.6% (Wille et al.), about six times smaller than HSHDC. The tensile ductility of Ductal®—the only commercially available ultra-high performance concrete (with compressive strength comparable to HSHDC)—is only 0.1% (Chanvillard et al.), which is an order of magnitude smaller than HSHDC. This gain of tensile ductility in HSHDC is needed to sustain extreme loads such as earthquakes, hurricanes, impacts, and blasts with minimum size of structural members.

The average tensile elastic modulus of HSHDC, obtained from four rectangular coupon specimens, is 48 GPa (6962 ksi) with a CV of 1%. In spite of the high tensile ductility of HSHDC, its elastic modulus of is comparable to that of Ductal®, VHSC, and UHPC.

The average split-tensile strength of HSHDC, obtained from three split-cylinders (4 in×8 in), is 17.0 MPa (2.5 ksi) with a CV of 8.5%.

The average MOR of HSHDC, obtained from three beams (14 in×4 in×4 in), is 31.8 MPa (4.6 ksi) with a CV of 14%. The average of the corresponding mid-point net deflections at MOR is 7.7 mm (0.3 in) which is 2.5% of the span length. The mid-point deflection at MOR of HSHDC is an order of magnitude higher (it in fact resembles reinforced concrete) than Ductal®, VHSC, and UHPC, which is facilitated by its extreme tensile ductility.

The average compressive strength of HSHDC, obtained from eight 51 mm (2 in) cubes, is 166 MPa (24.1 ksi) with a CV of 6.1%, and that from six 76 mm (3 in) cubes is 158 MPa (22.9 ksi) with a CV of 9.7%. In spite of its extreme tensile ductility, HSHDC matches the compressive strengths of Ductal®, VHSC, and UHPC.

The average compressive elastic modulus of HSHDC, obtained from three 51 mm (2 in) cubes is 51 GPa (7397 ksi) with a CV of 1%. These values of compressive strengths are similar to that of Ductal®, VHSC, and UHPC.

The development of HSHDC with the above composite material properties conclusively demonstrates that it is possible to integrate high compressive strength and high tensile ductility in a single concrete material using micromechanics-based design principles. Along with a very high compressive strength due to a densely packed matrix, HSHDC exhibits pseudo-strain hardening in tension enabled by the deliberate tailoring of fiber, matrix, and their interface. This combination of strength and ductility is expected to significantly enhance the load bearing and energy absorption capacities of the materials for building truly resilient structures of the 21st century.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A fiber-reinforced brittle matrix composite for structural and architectural applications, comprising a mixture of:
uniformly distributed discontinuous short fibers with a volume fraction between 1% to 4%;
a binder, which may be a cementitious matrix comprising of a hydraulic cement and water, or an inorganic polymer;
recycled materials acting as either pozzolanic/cementitious materials or fillers; and
inert filler material.

2. The composite of claim 1 wherein said composite having compressive strength in excess of 130 MPa.

3. The composite of claim 2 wherein said composite having compressive strength in excess of 180 MPa.

4. The composite of claim 1 wherein said composite having tensile strength in excess of 8 MPa.

5. The composite of claim 1 wherein said composite having tensile strength in excess of 10 MPa.

6. The composite of claim 1 wherein said composite exhibiting strain-hardening behavior under tension with at least 1% strain capacity.

7. The composite of claim 1 wherein said fiber is selected from a group consisting of aramid, high modulus polyethylene, polyvinyl alcohol and steel.

8. The composite of claim 1 wherein said fibers have an average diameter of 10 to 100 micrometer and an average length of 4 to 30 mm.

9. The composite of claim 1 wherein said recycled material is selected from a group consisting of silica fume, fly ash, rice husk ash and mixtures thereof.

10. The composite of claim 1 wherein said inert filler material is selected from crystalline silica materials ranging in size from 0.01 to 0.3 mm.

11. The composite of claim 1 wherein said binder is selected from the group consisting essentially of low calcium aluminate cements.

12. The composite of claim 1 wherein said binder is selected from the group consisting essentially of Class H oil well cement, Type I cement, and Type V cement.

13. The composite of claim 1 wherein the weight ratio of water to binder is in the range of 0.12 to 0.30.

14. The composite of claim 1, further comprising fine aggregates at a weight ratio of the fine aggregates to binder up to 2.0.

15. The composite of claim 14 wherein said fine aggregates is sand.

16. The composite of claim 1, further comprising ultra fine filler material at a weight ratio of the ultra fine filler material to binder up to 1.0.

17. The composite of claim 16 wherein said ultra fine filler material is crushed quartz.

18. The composite of claim 1, further comprising a water reducing agent present at a weight ratio of the water reducing agent to binder up to 0.03.

19. A fiber-reinforced brittle matrix composite for structural and architectural applications, comprising a mixture of:
uniformly distributed discontinuous short fibers with a volume fraction between 1% to 4%;
a binder, which may be a cementitious matrix comprising of a hydraulic cement and water, or an inorganic polymer;
recycled materials acting as either pozzolanic/cementitious materials or fillers; and
inert filler material,
wherein said composite having compressive strength in excess of 130 MPa, tensile strength in excess of 8 MPa, and exhibiting strain-hardening behavior under tension with at least 1% strain capacity.

20. The composite of claim 19 wherein said composite having compressive strength in excess of 180 MPa.

21. The composite of claim 19 wherein said composite having tensile strength in excess of 10 MPa.
